(19) United States
(12) Patent Application Publication
(10) Pub. No.: US 2006/0256247 A1
(43) Pub. Date: Nov. 16, 2006

(54) FILM PATTERN, DEVICE, ELECTRO-OPTIC DEVICE, ELECTRONIC APPARATUS, METHOD OF FORMING THE FILM PATTERN, AND METHOD OF MANUFACTURING ACTIVE MATRIX SUBSTRATE

(75) Inventors: Toshimitsu Hirai, Suwa (JP); Katsuyuki Moriya, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/382,532

(22) Filed: May 10, 2006

(30) Foreign Application Priority Data
May 11, 2005 (JP) 2005-138091

(51) Int. Cl. G02F 1/136

(52) U.S. Cl. 349/42

(57) ABSTRACT

A method of forming a film pattern by disposing a functional liquid on a substrate includes a step of forming a bank on the substrate, the bank corresponding to an area on which the film pattern is to be formed, a step of disposing the functional liquid to the area partitioned by the bank, and a step of curing the functional liquid to form the film pattern, one of a polysilazane liquid and a polysiloxane liquid is applied, exposed, developed, patterned, and burnt, thereby forming the bank made of a material having a hydrophobic group in the side chain and a siloxane bond as a framework in the step of forming the bank, and a liquid containing one of a water type dispersion medium and a water type solvent is used as the functional liquid.

### BACKGROUND OF THE INVENTION

1. Technical Field

The present invention relates to a film pattern, a device, an electro-optic device, an electronic apparatus, a method of forming the film pattern, and a method of manufacturing an active matrix substrate.

2. Related Art

In the past, a photolithography process has been frequently used for manufacturing fine wiring patterns (film patterns) used in, for example, a semiconductor integrated circuit. In contrast, in recent years, a manufacturing method using a droplet discharge process has been proposed. In this manufacturing method, a functional liquid (ink for forming a wiring pattern) containing a functional material (conductive micro particles) for forming the wiring pattern is discharged from a droplet discharging head on to a substrate to dispose the material on a pattern forming surface, thereby forming the wiring pattern. And the manufacturing method is considered to be very effective because it can cope with high-mix low-volume production.

Incidentally, in recent years, a circuit for composing a device has become more and more high-density, and regarding the wiring patterns thereof, for example, a further fine pitch or a further fine line is required.

However, if it is attempted to form such fine wiring patterns by the manufacturing method using the droplet discharge process, it is particularly difficult to obtain a sufficient preciseness in the width of the wiring. Therefore, a method is proposed that a bank is provided on the substrate as a partitioning member followed by providing a surface treatment for providing the bank with lyophobicity and for providing other sections with lyophilicity.

Further, if it is attempted that the wiring pattern is formed using the droplet discharge process, a thermal process with relatively high temperature is required especially from necessity of burning conductive micro particles as a functional material for forming the wiring pattern. However, especially in the case in which the wiring pattern is formed using the bank, the bank made of an organic material typically used, which has poor resistance to the thermal process, sometimes causes a problem of meltdown during the thermal process.

Therefore, as an inorganic bank having strong resistance especially to the thermal process, use of a bank made of photosensitive polysilazane coating film as disclosed in, for example, JP-A-2002-72504 can be considered.

However, the bank made of photosensitive polysilazane coating film mentioned above does not exert sufficient lyophobicity to a functional liquid (ink for forming a film pattern) of an organic solvent group, and accordingly, a surface treatment (a lyophobic process) with a fluorocarbon gas or the like is required.

However, such a surface treatment makes the process complicated and degrades productivity. In particular, if it is attempted that a first functional film is formed by disposing a functional liquid in the bank and then a second functional film is formed thereon by disposing another functional liquid, the surface treatment (the lyophobic process) needs to be performed once again prior to disposing the second functional liquid, thus making the process further more complicated. This is because the thermal treatment in forming the first functional film makes the fluorine be eliminated from the bank to remove or degrade the lyophobicity, and accordingly, it becomes necessary to perform the surface treatment (the lyophobicity process) once again prior to disposing the second functional liquid.

### SUMMARY

In consideration of the circumstance described above, the invention has an advantage of providing a method of forming a film pattern capable of eliminating a surface process (lyophobic process) to the bank, thereby simplifying the process to enhance the productivity, a film pattern obtained by the method, further a device, an electro-optic device, an electronic apparatus, and a method of manufacturing an active matrix substrate.

In order for obtaining the advantage described above, a method of forming a film pattern according to the invention, which is a method of forming a film pattern by disposing a functional liquid on a substrate, includes

a step of forming a bank on the substrate, the bank corresponding to an area on which the film pattern is to be formed, a step of disposing the functional liquid to the area partitioned by the bank, and a step of curing the functional liquid to form the film pattern, one of a polysilazane liquid and a polysiloxane liquid is applied, exposed, developed, patterned, and burnt, thereby forming the bank made of a material having a hydrophobic group in the side chain and a siloxane bond as a framework in the step of forming the bank, and a liquid containing one of a water type dispersion medium and a water type solvent is used as the functional liquid.

According to the method of forming a film pattern, since the polysilazane liquid or the polysiloxane liquid is applied, patterned, and then burnt, thereby forming a bank made of a material having a hydrophobic group in the side chain and a siloxane bond as a framework, the obtained bank, which has an inorganic framework as a principle component, becomes to have strong resistance to a thermal process. Therefore, if it is required that a thermal process is performed at relatively high temperature in the curing process of the functional liquid, for example, the bank can sufficiently cope with the thermal process without causing a problem of meltdown of the bank. Further, since the obtained bank is made of a material having a structure including a hydrophobic group in the side chain, the bank exerts a preferable water-repellent property as it stands without performing a surface process for providing lyophobicity. Therefore, it becomes to exert preferable water-repellent property particularly to the functional liquid composed of a water type liquid. Accordingly, the process can be simplified because the lyophobic process for the bank can be eliminated, thus the productivity can be enhanced, and the pattern accuracy of the film pattern derived from the functional liquid can sufficiently be improved.

Further, in the method of forming a film pattern, the hydrophobic group is preferably a methyl group.

Thus, the bank becomes to exert a further preferable water-repellent property, and accordingly, the pattern accuracy of the film pattern derived from the functional liquid can further be improved.

Further, in the method of forming a film pattern, as the polysilazane liquid or the polysiloxane liquid, a photosensitive polysilazane liquid or a photosensitive polysiloxane liquid containing a photoacid generator and functioning as a positive type resist is preferably used, respectively.

By arranging that the polysilazane liquid or the polysiloxane liquid functions as the positive type resist, the pattern accuracy of the bank derived from the material can further be improved, and accordingly, the pattern accuracy of the film pattern obtained from the bank can also be improved.

Further, in the method of forming a film pattern, the functional material included in the functional liquid can be a conductive material.

In this case, a conductive pattern such as a wiring pattern can particularly be formed as the film pattern.

Further, another method of forming a film pattern according to the invention, which is a method of forming a film pattern by disposing a functional liquid on a substrate, includes a step of forming a bank on the substrate, the bank corresponding to an area on which the film pattern is to be formed, a step of disposing a first functional liquid to the area partitioned by the bank, a step of disposing a second functional liquid on the disposed first functional liquid, and a step of forming the film pattern composed of a plurality of materials stacked one another by performing a predetermined process on the first functional liquid and the second functional liquid stacked one another in the area partitioned by the bank, and one of a polysilazane liquid and a polysiloxane liquid is applied, exposed, developed, patterned, and burnt, thereby forming the bank made of a material having a hydrophobic group in the side chain and a siloxane bond as a framework in the step of forming the bank, and a liquid containing one of a water type dispersion medium and a water type solvent is used as the first functional liquid, and a liquid containing one of a water type dispersion medium and a water type solvent is used as the second functional liquid.

According to the method of forming a film pattern, since the polysilazane liquid or the polysiloxane liquid is applied, patterned, and then burnt, thereby forming a bank made of a material having a hydrophobic group in the side chain and a siloxane bond as a framework, the obtained bank, which has an inorganic framework as a principle component, becomes to have strong resistance to a thermal process. Therefore, if it is required that a thermal process is performed at relatively high temperature in the curing process of the functional liquid, for example, the bank can sufficiently cope with the thermal process without causing a problem of meltdown of the bank. Further, since the obtained bank is made of a material having a structure including a hydrophobic group in the side chain, the bank exerts a preferable water-repellent property as it stands without performing a surface process for providing lyophobicity. Therefore, it becomes to exert preferable water-repellent property particularly to the functional liquid composed of a water type liquid. Accordingly, the process can be simplified because the lyophobic process for the bank can be eliminated, thus the productivity can be enhanced, and the pattern accuracy of the film pattern derived from the functional liquid can sufficiently be improved. Further, since the obtained bank becomes to have a water-repellent property as it stands, in the case in which the film pattern is formed from the first functional liquid and then the second functional liquid is disposed thereon, even if a thermal process is preformed in, for example, forming the film pattern, it does not make the water-repellent property of the bank to disappear or to be remarkably degraded. Therefore, since there is no need for performing the lyophobic process for the bank prior to disposing the second functional liquid, thus further simplifying the process, and enhancing the productivity.

Further, in the method of forming a film pattern, the hydrophobic group is preferably a methyl group.

Thus, the bank becomes to exert a further preferable water-repellent property, and accordingly, the pattern accuracy of the film pattern derived from the functional liquid can further be improved.

Further, in the method of forming a film pattern, as the polysilazane liquid or the polysiloxane liquid, a photosensitive polysilazane liquid or a photosensitive polysiloxane liquid containing a photoacid generator and functioning as a positive type resist is preferably used, respectively.

By arranging that the polysilazane liquid or the polysiloxane liquid functions as the positive type resist, the pattern accuracy of the bank derived from the material can further be improved, and accordingly, the pattern accuracy of the film pattern obtained from the bank can also be improved.

Further, in the method of forming a film pattern, the first functional liquid and the second functional liquid can contain different functional materials from each other.

In this case, the film pattern derived from the functional liquids can be a superior film pattern provided with a plurality of different functions.

Further, in the method of forming a film pattern, the first functional liquid is preferably cured prior to the step of disposing the second functional liquid on the disposed first functional liquid.

By thus arranged, since it can be prevented that the functional material in the first functional liquid is mixed with the functional material in the second functional liquid, the film patterns in the stacked structure derived from the respective functional materials can exert the functions in accordance with the respective functional materials, for example, a plurality of different functions.

Further, in the method of forming a film pattern, the functional materials contained in the first functional liquid and the second functional liquid can be both conductive materials.

In this case, the obtained film patterns can be made conductive, and accordingly, the film pattern can be used as wiring.

Still further, in the method of forming a film pattern, the second functional liquid can contain a second functional material for taking on a primary function of the film pattern to be formed while the first functional liquid can contain a first functional material for enhancing adhesiveness between the second functional material and the substrate.

By thus arranged, the adhesiveness of the film pattern formed of the second functional material with the substrate can be preferable, and accordingly, the film pattern can be prevented from peeling off the substrate.

Note that the primary function mentioned above means a main function of the obtained film pattern. For example, if the film pattern is formed as a wiring pattern, it is mainly the function of conducting an electrical current.

Further, as the second functional material exerting such a primary function, silver and copper can be cited. And, as the first functional material for enhancing the adhesiveness between such a material and the substrate, chromium, manganese, iron, nickel, molybdenum, titanium, tungsten, and so on can be cited.

Further, in the method of forming a film pattern, one of the first functional liquid and the second functional liquid can contain a main material for taking on the primary function of the film pattern to be formed while the other can contain a material for suppressing electromigration of the main material.

By thus arranged, since the obtained film pattern is composed of a layer formed of the main material and a layer formed of a material for suppressing electromigration of the main material, the electromigration of the main material can be suppressed.

Note that the electromigration is a phenomenon in which an atom is moved along the stream of electrons when a current flows through a wiring for a long period of time, and causes increase in the wiring resistance or breaking of wire.

As the material for suppressing the electromigration, titanium and so on can be cited.

Further, in the method of forming a film pattern, one of the first functional liquid and the second functional liquid can contain a main material for taking on the primary function of the film pattern to be formed while the other can contain a material having an insulating property.

In this case, if the film pattern might have a contact with other conductive elements, the electrical connection between the conductive element and the main material can be prevented.

Further, in the method of forming a film pattern, one of the first functional liquid and the second functional liquid can contain a main material for taking on the primary function of the film pattern to be formed while the other can contain a material for suppressing plasma damage of the main material. In this case, the material for suppressing the plasma damage of the main material can preferably be a barrier material for suppressing diffusion caused by the plasma damage.

By thus arranged, particularly in the case in which the film pattern is irradiated with plasma, it can be prevented that the pattern made of the main material in the film pattern is damaged by the plasma irradiation.

A film pattern according to another aspect of the invention is formed by the method described above.

Since the bank for forming the film pattern can sufficiently cope with the thermal process as described above, the film pattern can be patterned by the bank with accuracy. Further, since the lyophobic process for the bank can be eliminated, the productivity can be enhanced.

A device according to another aspect of the invention includes the film pattern.

By providing with the film pattern patterned with accuracy and offering enhanced productivity as described above, the device itself also becomes preferable.

An electro-optic device according to another aspect of the invention includes the device.

By providing with the preferable device as described above, the electro-optic device itself also becomes preferable.

An electronic apparatus according to another aspect of the invention includes the electro-optic device.

By providing with the preferable electro-optic device as described above, the electronic apparatus itself also becomes preferable.

A method of manufacturing an active matrix substrate according to another aspect of the invention includes (a) a step of forming a gate wiring on a substrate, (b) a step of forming a gate insulating film on the gate wiring, (c) a step of stacking a semiconductor layer via the gate insulating film, (d) a step of forming a source electrode and a drain electrode on the gate insulating layer, (e) a step of disposing an insulating material on the source electrode and the drain electrode, and (f) a step of forming a pixel electrode on the disposed insulating material, and the method of forming a film pattern described above is used in at least one of the steps (a), (d), and (f).

According to the method of manufacturing an active matrix substrate, at least one of the gate wiring, the source electrode, and the drain electrode can be formed with accuracy and the preferable productivity.

### BRIEF DESCRIPTION OF THE DRAWINGS

The invention will now be described with reference to the accompanying drawings, wherein like numbers refer to like elements.

FIG. 1 is a schematic perspective view of a droplet discharge device.

FIG. 2 is a schematic view for explaining a principle of discharging a liquid substance using a piezo method.

FIGS. 3A through 3D are schematic views for explaining a method of forming a wiring pattern according to a first embodiment of the invention along the steps of the process.

FIGS. 4A through 4E are also schematic views for explaining a method of forming a wiring pattern according to the first embodiment of the invention along the steps of the process.

FIGS. 5A through 5C are also schematic views for explaining a method of forming a wiring pattern according to the first embodiment of the invention along the steps of the process.

FIGS. 6A through 6C are again schematic views for explaining a method of forming a wiring pattern according to the first embodiment of the invention along the steps of the process.

FIG. 7 is a schematic view for explaining a second embodiment of the invention.

FIG. 8 is a schematic view for explaining a third embodiment of the invention.

FIG. 9 is a schematic view for explaining a fourth embodiment of the invention.

FIG. 10 is a plan view of a liquid crystal display device seen from an opposed substrate.

FIG. 11 is a cross-sectional view along the H-H′ line of FIG. 10.

FIG. 12 is a circuit diagram of an equivalent circuit of the liquid crystal display device.

FIG. 13 is a partial enlarged cross-sectional view of the liquid crystal display device.

FIG. 14 is a partial enlarged cross-sectional view of an organic EL device.

FIGS. 15A through 15D are schematic views for explaining a process of manufacturing a thin film transistor.

FIG. 16 is a perspective exploded view showing another form of the liquid crystal display device.

FIGS. 17A through 17C are perspective views showing specific examples of an electronic apparatus according to the invention.

### DESCRIPTION OF THE EMBODIMENTS

The embodiments of the invention are explained with reference to the accompanying figures. Here, in each of figures, contraction scales of layers and parts may be different so as to have recognizable size on each of figures.

### First Embodiment

Firstly, a method of forming a film pattern according to a first embodiment of the invention will be explained, in which ink (functional liquid) for forming a wiring pattern (the film pattern) containing conductive micro particles is discharged as a droplet from a discharging nozzle of a droplet discharging head to form the wiring pattern (the film pattern) between the banks, namely in an area partitioned by the banks which are formed on the substrate in accordance with the wiring pattern. It is assumed in the embodiment that the wiring pattern (the film pattern) composed of a plurality of layers stacked one another is formed by especially discharging two kinds of functional liquid different from each other.

As the ink (the functional liquid) for forming the wiring pattern, in consideration that the bank made of a material having the siloxane bond with hydrophobicity such as poly-methyl siloxane as the framework, namely the bank made of poly-siloxane as the framework as described later, a liquid substance containing in particular water type of dispersion medium or a solvent is used. Specifically, it is composed of a dispersion liquid dispersing the conductive micro particles in the water type of dispersion medium such as water or alcohol, or a dispersion liquid dispersing organo-silver compounds or silver oxide nanoparticles in the water type of dispersion medium.

In the present embodiment, metal micro particles including either one of, for example, gold, silver, copper, iron, chromium, manganese, molybdenum, titanium, palladium, tungsten, and nickel, or oxides thereof, micro particles of electrically conductive polymers or superconductive materials can be used as the conductive micro particles.

An organic material may be coated over the surface of these conductive micro particles in order to improve dispersion.

The diameter of a conductive micro particle is preferably in a range between 1 nm and 0.1 micron. If the particle sizes are greater than 0.1 μm, clogging may occur in the discharging nozzle of the droplet discharging head described below. On the other hand, if the size is smaller than 1 nm, the volume ratio of coating material to the conductive micro particles becomes large and the ratio of organic material in the obtained film becomes too much.

The dispersion medium is not specifically limited if it can disperse the conductive micro particles and is of water type not making particles aggregate. For example, other than water, an alcohol group including methanol, ethanol, propanol, and butanol can be exemplified.

The surface tension of the solution including conductive micro particles is preferably in the range no smaller than 0.02 N/m and no greater than 0.07 N/m. If the surface tension is less than 0.02 N/m, droplets easily veeringly fly when droplets are discharged by an inkjet method since the wettability of ink compounds to the discharging nozzle surface increases, on one hand. On the other hand, if the surface tension is more than 0.07 N/m, it becomes difficult to control the amount of discharging and timing thereof since the configuration of the meniscus becomes unstable at the discharging nozzle edge. In order to arrange the surface tension, a small amount of materials for arranging the surface tension such as fluorine, silicon, nonion can preferably be added to the liquid material as long as it can prevent the contact angle with the surface of the substrate from decreasing dramatically. A nonion group material for arranging the surface tension improves the wettability of the liquid material to the substrate and the leveling property of the film, and contributes to prevent the coated film from having fine surface unevenness. The materials for arranging the surface tension may include organic compounds such as alcohol, ether, ester and ketene if they are necessary.

The viscosity of the solution is preferably no smaller than 1 mPa·s and no greater than 50 mPa·s. If the viscosity of the solution is less than 1 mPa·s, the periphery of the discharging nozzle is easily contaminated with flowed ink when the liquid material is discharged as droplets by an inkjet method, on the one hand. On the other hand, if the viscosity of the solution is more than 50 mPa·s, the discharging nozzle hole is easily clogged, making it difficult to smoothly discharge droplets.

As the substrate on which the wiring pattern is formed, various kinds of materials such as glass, quartz glass, a silicon wafer, a plastic film, or a metal plate can be used. Further, the surface of each of the substrates formed of the various materials can be provided with a semiconductor film, a metal film, a dielectric film, or an organic film as a foundation layer.

Note that, as a discharge technology used for the droplet discharge process, the charge control method, the pressure vibration method, electromechanical conversion method, electrothermal conversion method, electrostatic absorption method, and so on can be cited. In the charge control method, the material is electrically charged by a charge electrode and discharged from a discharging nozzle while its flight orientation is controlled by a deflection electrode. Further, in the pressure vibration method, the material is discharged from the tip of the discharging nozzle by being applied with very high pressure of about 30 kg/cm², and when no control voltage is applied, the material is forwarded straight to be discharged from the discharging nozzle, and when the control voltage is applied, an electrostatic repelling force is generated in the material to cause the material to fly in various directions and not to be discharged from the discharging nozzle. Further, in the electromechanical conversion method, the characteristics of the piezoelectric element that distorts in response to a pulsed electric signal are utilized, and when the piezoelectric element distorts, pressure is applied to a chamber containing the material via an elastic member to push the material out of the chamber to discharge it from the discharging nozzle.

Further, in the electrothermal conversion method, the material is rapidly vaporized to generate a bubble by a heater provided in a chamber containing the material, and the material in the chamber is discharged by a pressure caused by the bubble. In the electrostatic absorption method, minute pressure is applied to a chamber containing the material to form a meniscus at the discharging nozzle, and then electrostatic absorption force is applied in this condition to take the material out of the nozzle. Other than the above methods, a method utilizing viscosity alteration of fluid by electric field or a method for flying the material by discharge sparks can also be adopted. The droplet discharge method has advantages that there is little waste in using the material and that a desired amount of material can precisely be disposed on a desired position. Note that the weight of one droplet of the liquid material (fluid) discharged by the droplet discharge method is, for example, 1 through 300 nanograms.

In the present embodiment, the electromechanical conversion type of droplet discharge device (inkjet device) using the piezo element (the piezoelectric element) is used as such a device as performing droplet discharge.

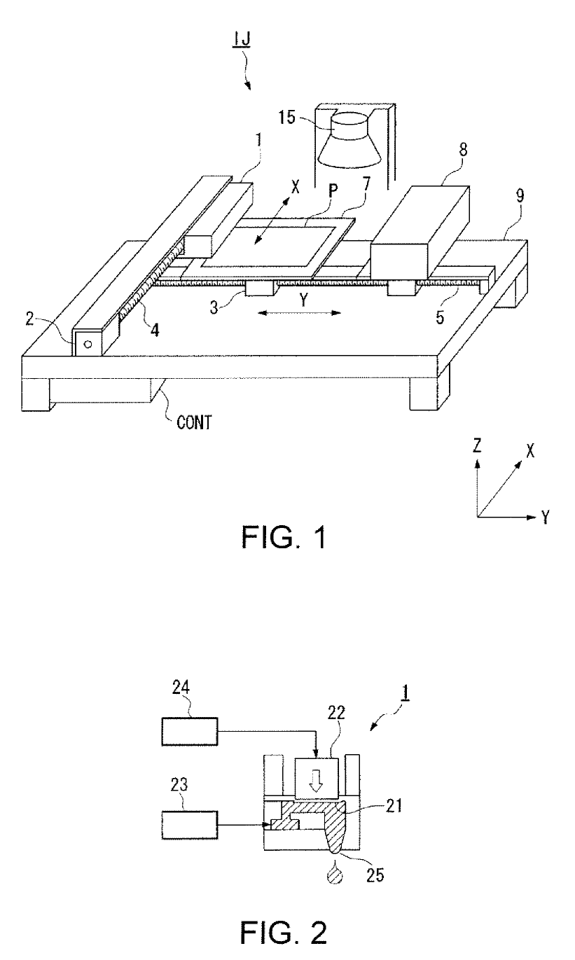

FIG. 1 is a perspective view schematically showing the configuration of the droplet discharge device IJ.

The droplet-discharging device IJ includes a droplet discharging head 1, a driving shaft for the X-axis direction 4, a guiding shaft for the Y-axis direction 5, a controller CONT, a stage 7, a cleaning mechanism 8, a base 9 and a heater 15.

The stage 7 supports the substrate P, on which the liquid material (the ink for forming the wiring pattern) is disposed by the droplet-discharging device IJ, and includes a fixing mechanism (not shown in the figure) to fix the substrate P to the reference position.

The droplet discharging head 1 is provided with a plurality of discharging nozzles as a multiple-nozzles type and its longitudinal direction is coincided with the X-axis direction. The plurality of discharging nozzles is provided on the lower surface of the droplet discharging head 1 at constant intervals. It is arranged that the ink for forming the wiring pattern containing the conductive micro particles described above is discharged from the discharging nozzles of the droplet discharging head 1 to the substrate P supported by the stage 7.

The driving shaft 4 for the X-axis direction is coupled to a driving motor 2 for the X-axis direction. The driving motor 2 for the X-axis direction is composed of a stepping motor and the like that drives the driving shaft 4 for the X-axis direction when a driving signal for the X-axis direction is supplied from the controller CONT. When the driving shaft 4 for the X-axis direction rotates, the droplet discharging head 1 moves in the X-axis direction.

The guiding shaft 5 for the Y-axis direction is fixed so as not to move relatively to the base 9. The stage 7 is provided with a motor 3 for the Y-axis direction. The driving motor 3 for the Y-axis direction is a stepping motor and the like that moves the stage 7 in the Y-axis direction when a driving signal for the Y-axis direction is supplied from the controller CONT.

The controller CONT supplies the droplet discharging head 1 with voltages for controlling to discharge droplets. Further, the controller supplies a driving pulse signal to the driving motor 2 for the X-axis. This driving pulse signal controls the movement of the droplet discharging head 1 in the X-axis direction. The controller also supplies a driving pulse signal to the driving motor 3 for the Y-axis. This driving pulse signal controls the movement of the stage 7 in the Y-axis direction.

The cleaning mechanism 8 is for cleaning the droplet discharging head 1. The cleaning mechanism 8 is provided with a driving motor for the Y-axis direction not shown in the figures. The driving motor for the Y-axis direction moves the cleaning mechanism along the guiding shaft 5 for the Y-axis direction. The movement of the cleaning mechanism 8 is also controlled by the controller CONT.

The heater 15 is a unit to process the substrate P with heat using a lamp annealing process, which evaporates the solvent included in the solution applied on the substrate P to dry the substrate P. The controller CONT also controls turning on and off the power source of the heater 15.

The droplet discharging device IJ is arranged to discharge droplets to the substrate P from the plurality of discharging nozzles arranged on the lower surface of the droplet discharging head 1 in the X-axis direction while relatively scanning the droplet discharging head 1 and the stage 7 supporting the substrate P.

FIG. 2 is a schematic view for explaining the principle of discharging the liquid material according to the piezoelectric method.

In FIG. 2, a piezo element 22 is placed adjacent to a liquid chamber 21 that stores the liquid material (the ink for forming the wiring pattern, a functional liquid). The liquid material is supplied to the liquid chamber 21 via a liquid material supplying system 23 including a material tank for storing the liquid material. The piezo element 22 is connected to a drive circuit 24, and by applying voltage to the piezo element 22 via the drive circuit 24 to distort the piezo element 22, the fluid chamber is also distorted to discharge the liquid material from the discharging nozzle 25. In this case, the amount of the distortion of the piezo element 22 is controlled by changing the values of applied voltages. Further, the speed of the distortion of the piezo element 22 is controlled by changing the frequency of applied voltages. A droplet discharging method with a piezo method has advantage that bad effects are hardly applied to the material compositions since the materials are not heated.

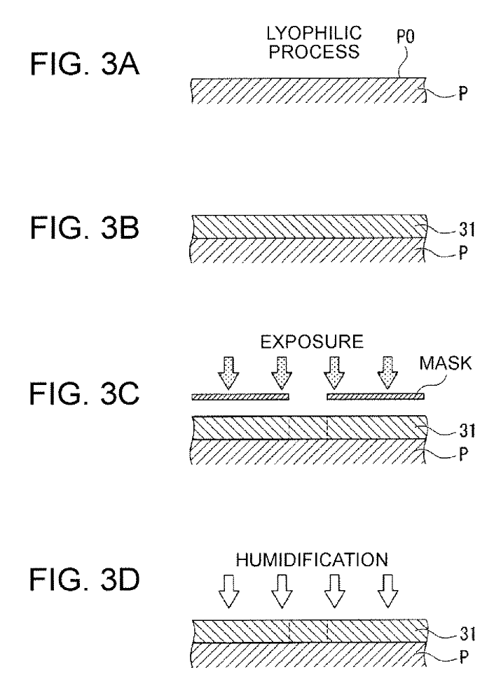

Further, in the present embodiment, as described above, the lyophilic process is executed on the substrate prior to forming the bank corresponding to the wiring pattern on the substrate. The lipophilic process is for improving the wettability of the substrate P to the discharged ink preparing for disposition of the ink (the functional liquid) by discharging as described below, and for forming a film P0 having superior lyophilicity (hydrophilicity) such as TiO₂ on the surface of the substrate P as shown in FIG. 3A. Alternatively, the film P0 with superior lyophilicity can be formed by evaporating hexamethyldisilazane (HMDS) to adhere (HMDS process) to the surface of the substrate P to be processed. Further, the surface of the substrate P can be made lipophilic by roughening the surface of the substrate P.

Bank Forming Step

After thus performing the lipophilic process, the bank is formed on the substrate P.

The bank is a member functioning as a separating member, and can be formed using a desired process such as a lithography process or a printing process. For example, in using the lithography method, firstly a material for forming the bank, namely polysilazane solution is applied on the substrate P in accordance with a desired bank height as shown in FIG. 3B using a predetermined method such as a spin coat method, a spray coat method, a roll coat method, a die coat method, a dip coat method, and so on.

Here, the polysilazane solution to become a material for forming the bank is a solution composed mainly of polysilazane, and in particular, a photosensitive polysilazane liquid containing polysilazane and a photoacid generator is preferably used. The photosensitive polysilazane liquid functions as a positive resist, which is directly patterned by exposure and development processes. Note that, as such photosensitive polysilazane, the photosensitive polysilazane disclosed in JP-A-2002-72504 can be exemplified. Further, as the photooxidation agent included in the photosensitive polysilazane, one disclosed in JP-A-2002-72504 can also be used.

A part of this polysilazane is partially hydrolyzed by humidification as shown in the following formula 2 or 3 if the polysilazane is polymethylsilazane, for example, as shown in the following formula 1. Further, this hydrolyzed polysilazane becomes polymethylsiloxane [-(SiCH_{O}_{1.5})n-] with condensation as shown in the following formulas 4 through 6 by heating under 400° C. Note that, in the following formulas 2 through 6, only basic element units (repeated units) in the compounds are shown by simplifying chemical formulas in order to explain reaction mechanisms.

The poly-methyl siloxane thus formed has the siloxane bond (polysiloxane) as a framework, and has a methyl group in the side chain. Therefore, since the framework as the primary component is an inorganic matter, it has a strong resistance to the thermal process. Further, since it has the methyl group as the hydrophobic group in the side chain, it exerts good water-repellent property as it stands. Note that, although not shown with a chemical formula, if the heating process is executed at temperature of 400° C. or higher, the methyl group is also eliminated to form polysiloxane, thus the water-repellent property is dramatically degraded. Therefore, in the present embodiment of the invention, in forming the bank in particular from the polysilazane solution, the temperature in heating process is preferably set to be lower than 400° C.
—(SiCH₃(NH)_{1.5})n- Formula 1:
SiCH₃(NH)_{1.5}+H₂O→SiCH₃(NH)(OH)+0.5NH₃ Formula 2:
SiCH₃(NH)_{1.5}+2H₂O→SiCH₃(NH)_{0.5}(OH)₂+NH₃ Formula 3:
SiCH₃(NH)(OH)+SiCH₃(NH)(OH)+H₂O→2SiCH₃O_{1.5}+2NH₃ Formula 4:
SiCH₃(NH)(OH)+SiCH₃(NH)_{0.5}(OH)₂→2SiCH₃O_{1.5}+1.5NH₃ Formula 5:
SiCH₃(NH)_{0.5}(OH)₂+SiCH₃(NH)_{0.5}(OH)₂→2SiCH₃O_{1.5}+NH₃+H₂O Formula 6:

Subsequently, the polysilazane thin film 31 thus obtained is prebaked on, for example, a hotplate at 110° C. for about one minute.

Then, as shown in FIG. 3C, the polysilazane thin film 31 is exposed using the mask. In this case, since the polysilazane thin film 31 functions as a positive type resist as described above, the portions to be removed by the succeeding developing process are selectively exposed. The exposure light source is selected as desired to be used from a high-pressure mercury-vapor lamp, a low-pressure mercury-vapor lamp, a metal halide lamp, a xenon lamp, an excimer laser, an X ray, an electron beam, and so on used in conventional photoresist exposure in accordance with the composition or the photosensitive property of the photosensitive polysilazane liquid. The energy amount of the irradiated light depends on the kind of light source or the thickness of the film, but is usually set to be no smaller than 0.05 mJ/cm², and preferably no smaller than 0.1 mJ/cm². Although the upper limit is not particularly defined, too much irradiation amount is not practically set in consideration of the process time. Therefore, it is usually set to be no greater than 10000 mJ/cm². Although the exposure process is preferably performed typically in an environmental atmosphere (in the atmosphere) or a nitrogen atmosphere, in order for promoting degradation of polysilazane, an atmosphere enriched in the content of oxygen can also be adopted.

According to such a disposure process, in the photosensitive polysilazane thin film 31 containing the photoacid generator, the acid is selectively generated inside the film in particular in the exposed sections, thus the Si—N bond of polysilazane is cleaved. And then, in reacting with moisture in the atmosphere, as shown in formulas 2 and 3, the polysilazane thin film 31 is partially hydrolyzed to finally generate silanol (Si—OH) bonds, thus the polysilazane is degraded.

Subsequently, in order for further promoting generation of silanol (Si—OH) bonds and the degradation of the polysilazane, as shown in FIG. 3D, the polysilazane thin film 31 thus exposed is processed with a humidification process at 25° C. in an environment of relative moisture of 80% for about four minutes, for example. By thus continuously supplying moisture in the polysilazane thin film 31, the acid, which has once contributed to cleave the Si—N bonds of the polysilazane, repeatedly functions as a cleaving catalytic agent. Although the Si—OH bonds occur during the exposure process, formation of the Si—OH bonds in the polysilazane is further promoted by executing the humidification process on the exposed film after the exposure process.

Note that the higher the humidity of the process atmosphere in such a humidification process is, the faster the ratio of forming the Si—OH bonds becomes. Note also that too much humidity might cause dew condensation on the surface of the film, and accordingly, the relative humidity no greater than 90% is practicable from this point of view. Further, in such a humidification process, it is enough to contact a gas containing moisture with the polysilazane thin film 31, and accordingly, it is enough to put the exposed substrate P inside the device for the humidification process and to continuously introduce the moisture containing gas to the device for the humidification process. Alternatively, it is possible to insert the exposed substrate P in the device for the humidification process in a humidity controlled condition with the moisture containing gas previously introduced therein, and to leave it for a desired period of time.

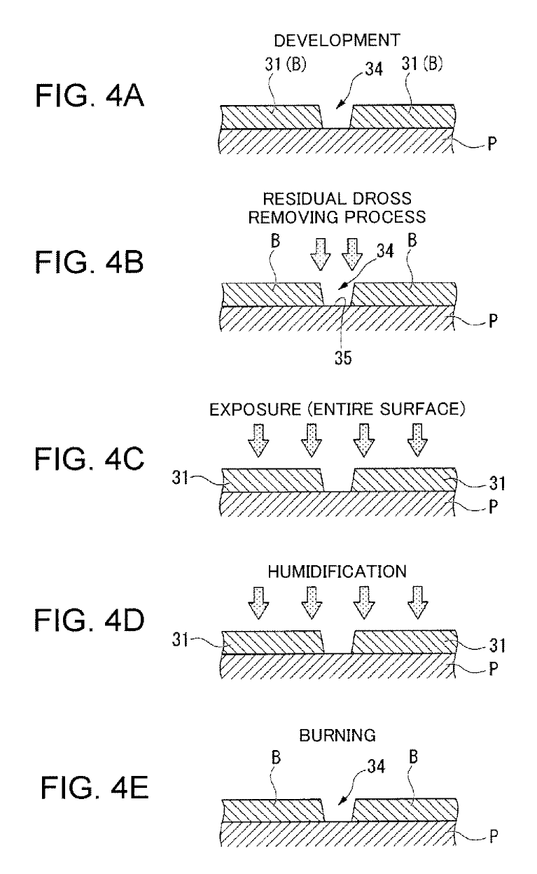

Subsequently, the polysilazane thin film 31 processed with the humidification process is processed with the developing process at 25° C. with, for example, tetramethyl ammonium hydroxide (TMAH) solution of 2.38% concentration to selectively remove the exposed sections, thereby forming the polysilazane thin film 31 as the desired bank shape as shown in FIG. 4A. Thus, the bank B corresponding to the area for forming the objective film pattern is formed, and at the same time, a groove like area 34 for forming the film pattern, for example, is also formed. Note that as the developing liquid, an alkali developing liquid other than the TMAH such as choline, sodium silicate, sodium hydroxide, potassium hydroxide, or the like can also be used.

Subsequently, as shown in FIG. 4B, a process for removing the residual dross between the obtained banks B is preformed after rinsing with purified water according to needs. As the residual dross removing process, an ultraviolet (UV) irradiation process for irradiating with ultraviolet light, an O₂ plasma process using oxygen as the process gas in the atmospheric conditions, a fluorinated acid process for etching the residual dross section with a fluorinated acid solution, and so on can be used. In the present embodiment, the fluorinated acid process is adopted, in which a contact process with a fluorinated acid water solution having concentration of 0.2% is performed for about 20 seconds. By performing such a residual dross removing process, a bottom section 35 of the film pattern forming area 34 formed between the banks B, which function as the mask, is etched selectively, thus the bank material and so on remaining thereon can be removed.

Subsequently, as shown in FIG. 4C, an entire surface exposure is preformed to the substrate P on the surface on which the banks B are formed. The exposure conditions are the same as the exposure conditions in the process shown in FIG. 3C. By thus performing the entire surface exposure, the banks B, which have not been exposed in the preceding process, are exposed. Thus, the polysilazane forming the banks B is partially hydrolyzed, and finally the silanol (Si—OH) bonds are generated to degrade the polysilazane.

Subsequently, as shown in FIG. 4D, the humidification process is performed again. The humidification conditions are the same as the humidification conditions in the process shown in FIG. 3D. By thus performing the humidification process, the polysilazane forming the banks B is further promoted to generate the Si—OH bonds.

Subsequently, as shown in FIG. 4E, a burning process for heating it at 350° C. for about 60 minutes, for example, is performed. By thus performing the burning process, the banks B made of polysilazane and transformed to Si—OH in the preceding humidification process are easily transformed to Si—O—Si by the burning process as shown in formulas 4 through 6, and are transformed to silica-ceramics film, such as poly-methyl siloxane, hardly (or not at all) including Si—NH bonds.

Since this makes the banks B made of poly-methyl siloxane (the silica-ceramics film) have siloxane bonds (polysiloxane) as the frameworks and the methyl groups as the hydrophobic groups in the side chains, the banks B become to have strong resistance to the thermal process and superior water-repellent property as they stand without requiring the lyophobic process.

Note that, if the burning process is performed with the burning temperature of 400° C. or higher, for example, the methyl groups in the side chains might be eliminated to remarkably degrade the water-repellent property. Therefore, the burning process is preferably performed with the burning temperature of lower than 400° C., and further preferably of about 350° C. or lower Functional Liquid Disposing Step

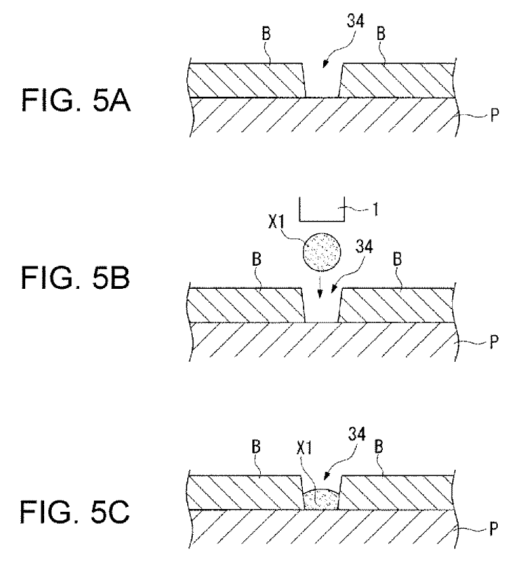

Subsequently, as shown in FIG. 5A, the ink (a first functional liquid) X1 for forming the wiring pattern is discharged using the droplet discharging device IJ described above and disposed on the substrate P exposed in the film pattern forming area 34 between the banks B. In the present embodiment of the invention, the liquid composed of conductive micro particles dispersed in a dispersion medium such as water is used as the wiring pattern ink (the first functional liquid) X1. Note that in the present embodiment, the wiring pattern ink L using chromium, for example, as the conductive micro particles is discharged. As the droplet discharging conditions, for example, ink weight of 4 through 7 ng/dot, ink speed (discharging speed) of 5 through 7 m/sec can be adopted. Further, the ambient atmosphere for discharging the droplets is preferably set to have the temperature of no higher than 60° C. and the humidity of no higher than 80%. Thus, more stable droplet discharging can be executed without any clogging in the discharging nozzles of the droplet discharging head 1.

In the material disposing step, as shown in FIG. 5B, the wiring pattern ink X1 is discharged from the droplet discharging head 1 as droplets, and the droplets are disposed on a part of the substrate P exposed in the film pattern forming area 34 between the banks B.

In this case, since the film pattern forming area 34 is surrounded by the banks B, the wiring pattern ink X1 can be prevented from extending beyond the predetermined position. Further, the banks B is made of a material having water-repellent property as described above, if a part of the discharged wiring pattern ink X1, which is of the water type, rides on the bank B, the part is repelled with the water-repellent property of the bank B to flow down in the film pattern forming area between the banks B. Further, since a part of the substrate P exposed in the film pattern forming area 34 is provided with lyophilicity, the discharged wiring pattern ink X1 becomes easy to extend on the part of the substrate P exposed in the film pattern forming area 34. Thus, as shown in FIG. 5C, the wiring pattern ink X1 can evenly be disposed in the film pattern forming area 34 between the banks B in the extending direction of the film pattern forming area 34.

Preliminary Drying Step

After discharging a predetermined amount of the wiring pattern ink X1 on the substrate P, a drying process for removing the dispersion medium is performed according to needs. And, by the drying process, the wiring pattern ink X1 is hardened to the extent that it is not mixed with a different kind of wiring pattern ink disposed on itself. The drying process can be executed by a process for heating the substrate P with a typical hotplate or an electric oven, or by lamp annealing. A light source used for lamp annealing is not particularly limited. An infrared lamp, a xenon lamp, a YAG laser, an Argon laser, a carbon dioxide gas laser and a excimer laser such as XeF, XeCl, XeBr, KrF, KrCl, ArF, ArCl can be used as the light source. The light sources having an output power of no less than 10 W and no greater than 5000 W can generally be used, but in the present embodiment, those of no less than 100 W and no greater than 1000 W are sufficient.

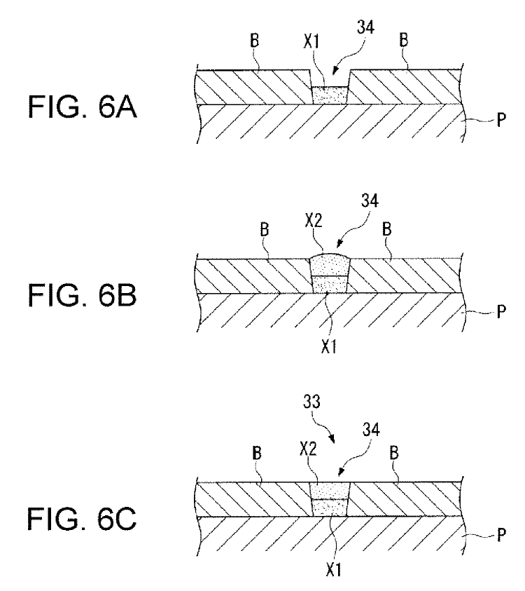

And, as shown in FIG. 6A, a layer of the wiring pattern ink X1 including chromium as the conductive micro particles is formed on the part of the substrate P in the film pattern forming area 34 by the preliminary drying process.

Note that, if the wiring pattern ink X1 and the different wiring pattern ink (a second functional liquid) to be discharged in the succeeding step are not mixed with each other without removing the dispersion medium of the wiring pattern ink X1, the preliminary drying process can be omitted.

Further, in the preliminary drying process, there are some cases, in which the wiring pattern ink X1 disposed on the substrate P becomes a porous body, depending on the drying conditions. For example, when heating at 120° C. for about five minutes, or heating at 180° C. for about 60 minutes, the wiring pattern ink X1 becomes a porous body. If the wiring pattern ink X1 becomes a porous body as described above, it is concerned that the second functional liquid (different metal) disposed on the wiring pattern ink X1 might enter the wiring pattern ink X1, thus the layer of the wiring pattern ink X1 does not obtain a desired function. Therefore, in the present preliminary drying process, the wiring pattern ink X1 is preferably dried with the drying conditions not causing the wiring pattern ink X1 to become a porous body. For example, by heating at 60° C. for about five minutes, heating at 200° C. for about 60 minutes, or heating at 250° C. for about 60 minutes, the wiring pattern ink X1 can be prevented form becoming a porous body.

In this case, the banks B are composed of a material having hydrophobic groups, and accordingly, exert water-repellent property as they stand without any surface treatments. Therefore, even if such a drying process by heating is performed, it does not occur that the water-repellent property disappears or is dramatically degraded. Accordingly, also in the case in which a different functional liquid (wiring pattern ink) is further disposed on the wiring pattern ink X1, it is not necessary to perform a surface treatment (a water-repellent process) on the banks B.

After thus forming the layer formed of the wiring pattern ink X1 (the first functional liquid), the wiring pattern ink (the second functional liquid) including different conductive micro particles is disposed on the wiring pattern ink X1, thereby forming a wiring pattern (a film pattern) composed of different kinds of wiring pattern ink stacked on the film pattern forming area 34. Note that in the present embodiment, a water type of wiring pattern ink X2 using silver as the conductive micro particles is used as the second functional liquid, and disposed on the wiring pattern ink X1.

Specifically, by performing the material disposing step described above once again with the wiring pattern ink X2, the wiring pattern ink X2 is disposed on the wiring pattern ink X1 as shown in FIG. 6B.

And, by performing the preliminary drying step described above once again, the dispersion medium of the wiring pattern ink X2 is removed, the wiring pattern 33 composed of the wiring pattern ink X1 and the wiring pattern ink X2 stacked on the film forming area 34 between the banks B as shown in FIG. 6C.

Note that a thermal process/optical process step described below can be performed without performing the preliminary drying step for removing the dispersion medium of the wiring pattern ink X2.

Thermal Process/Optical Process Step

It is necessary to completely remove the dispersion medium from the dried film after discharging process in order to improve the electrical contact among micro particles. Further, it is necessary to remove a coating material such as an organic material, which is used for improving dispersibility, if the coating material is applied on the surfaces of the conductive micro particles. Therefore, it is arranged that the substrate P processed with the discharging process is further processed with a thermal process and/or an optical process.

Although the thermal process and/or the optical process are usually executed in the atmosphere, they can also be executed in an environment with an inactive gas such as nitrogen, argon, or helium according to needs. The process temperature of the thermal process and/or the optical process is appropriately decided in consideration of the boiling point (the vapor pressure) of the dispersion medium, the nature or pressure of the ambient gas, thermal behavior of the micro particles such as dispersibility or oxidation property, presence or absence, or an amount of the coating material, an allowable temperature limit of a base member, and so on. For example, in order for removing the coating material made of an organic substance, burning at about 300° C. is necessary. Further, in case of using a substrate made of plastic or the like, it is preferably executed at a temperature no lower than the room temperature and no higher than 100° C.

In the present embodiment, in particular, the dispersion medium in the wiring pattern 33 composed of the wiring pattern ink X1 and the wiring pattern ink X2 is sufficiently removed by performing a heating process at 350° for about 60 minutes. In this case, the banks B, which have inorganic frameworks as the main components, have strong resistance to the thermal process, and exert sufficient resistance without causing a problem of meltdown in the conditions of the thermal process described above.

According to the process described above, the wiring pattern 33 composed of chromium and silver layers stacked on the film pattern forming area 34 between the banks B.

Note that it can be arranged that the functional liquid contains, instead of the conductive micro particles, a material for expressing conductivity by the thermal process or the optical process to develop conductivity in the wiring pattern 33 in the present thermal process/optical process step.

As explained above, since the banks B having water-repellent property as the nature of the material are used in the method of forming the wiring pattern 33 (the film pattern) according to the present embodiment, the banks B become to have preferable water-repellent property as they stand without particularly performing the lyophobic surface treatment to the banks B. Therefore, the banks B become to exert preferable water-repellent property particularly to the wiring pattern ink X1 (the first functional liquid) and the wiring pattern ink X2 (the second functional liquid) both composed of a water type liquid. Accordingly, the process can be simplified by eliminating the lyophobic process of the banks B, thus the productivity can be improved, and at the same time, the pattern accuracy of the wiring pattern 33 derived from the functional liquid can sufficiently be enhanced.

Further, since the obtained banks B have preferable water-repellent property as they stand, when the wiring pattern ink X2 is disposed on the wiring pattern ink X1 formed previously thereto, there is no need for performing the lyophobic process on the banks B, thus simplifying the process and enhancing the productivity.

Further, since the banks B, which have inorganic frameworks as the main component, have superior resistance to the thermal process, even when the film pattern composed of the wiring pattern ink X1 and X2 is processed with the burning process, the banks B exert sufficient resistance during the process without causing a problem of meltdown. Therefore, freedom of process can be enhanced.

Further, the wiring pattern 33 (the film pattern) thus obtained by such a forming method is patterned with great precision since the banks B can sufficiently cope with the thermal process. Moreover, since the lyophobic process for the banks B is not required, the productivity thereof can be enhanced.

Further, since the wiring composed of the stacked layers of chromium and the silver is formed in the film pattern forming area 34 between the banks B, silver in charge of the principal function of the wiring can surely be adhered to the substrate P by chromium.

Note that, although the banks B is particularly formed with the photosensitive polysilazane liquid functioning as a positive type of resist in the embodiment described above, the invention is not limited thereto, but the banks B can also be formed with a polysilazane liquid functioning as a negative type. Further, depending on the kind of the polysilazane liquid, the humidification processes shown in FIGS. 3D and 4D can be omitted.

Still further, it can be arranged that, as the forming material of the banks B, the polysiloxane liquid (the photosensitive polysiloxane liquid) is used instead of the photosensitive polysilazane liquid, and the banks B made of polysiloxane such as poly-methyl siloxane can directly be formed from the polysiloxane liquid.

Further, since the surfaces of the banks B are made lyophobic as described above, the wiring pattern ink X1 and X2 are repelled by the banks B to flow down in the film pattern forming area 34. However, in the case in which a part of the wiring pattern ink X1, X2 comes in contact with, for example, the upper surface of the bank B, microscopic dross sometimes remains on the upper surface of the bank B. Therefore, if, for example, the wiring pattern formed by the method of forming the wiring pattern according to the present embodiment is applied to a gate wiring of a TFT, it is concerned that the channel length of the TFT is varied to cause a problem of increase in the leakage current. Therefore, the process for removing the residual dross on the upper surfaces of the banks B is preferably performed after the wiring pattern 33 has been formed in the film pattern forming area 34. Specifically, the upper surfaces of the banks B are pared by performing a wet etching process, a dry etching process, an abrasive process or the like on the upper surfaces of the banks B, thereby removing the residual dross on the upper surfaces of the banks B.

Further, when removing the residual dross on the upper surfaces of the banks B, the upper surfaces of the banks B is preferably pared so that the upper surfaces of the banks B become in plane with the upper surface of the wiring pattern 33. As described above, by making the upper surfaces of the banks B in plane with the upper surface of the wiring pattern 33, for example, in the case in which the wiring pattern formed by the method of forming the film pattern according to the present embodiment is applied to the source line or the drain line of a TFT equipped to a liquid crystal display device, the flatness of an oriented film disposed on the TFT can be assured, thus preventing unevenness in a rubbing process or the like from occurring.

### Second Embodiment

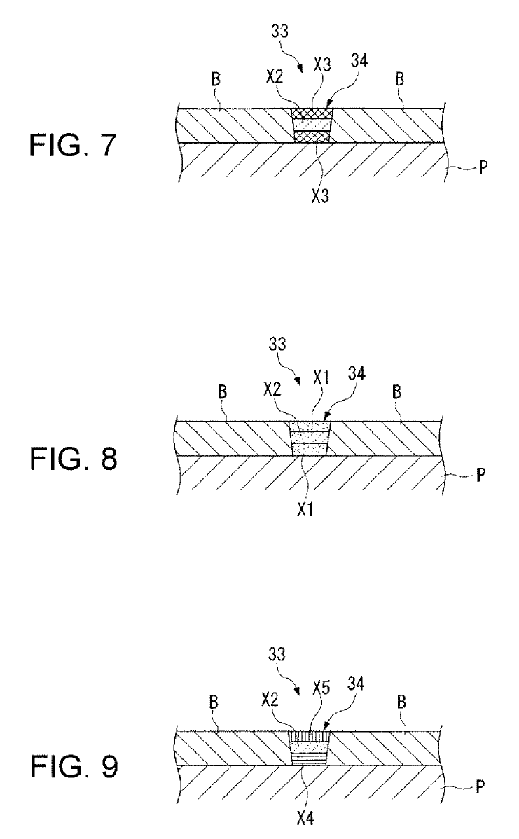

As a second embodiment, the wiring pattern 33 having a different configuration from the first embodiment will be explained with reference to FIG. 7. Note that in the second embodiment, different sections from the first embodiment will be explained.

In the present second embodiment, wiring pattern ink X3 using titanium as the conductive micro particles and the wiring pattern ink X2 using silver as the conductive micro particles are stacked in the film pattern forming area 34 by repeatedly performing the material disposing step and the preliminary drying step explained in the first embodiment as shown in FIG. 7. Note that as shown in the drawings, the wiring pattern ink X3, the wiring pattern ink X2, and again the wiring pattern ink X3 are stacked in the film pattern forming area 34 in this order from the side of the substrate P. Namely, the wiring pattern ink X2 is disposed in the film pattern forming area 34 so as to be sandwiched by the layers of the wiring pattern ink X3.

And, by performing the thermal process/optical process step explained in the first embodiment on the wiring pattern ink X2 and X3, the wiring pattern 33 composed of the layers of titanium, silver, and titanium stacked in this order is formed in the film pattern forming area 34.

Since the wiring composed of a stack of the titanium layer and the silver layer has the property of taking longer time to cause electromigration in comparison with a single layer of silver, the wiring pattern 33 composed of the silver layer sandwiched by the titanium layers as the present embodiment takes long time before the electromigration is caused. Therefore, according to the present embodiment, the wiring pattern 33 capable of suppressing occurrence of the electromigration can be obtained.

Note that as a material for delaying occurrence of the electromigration, in addition to titanium mentioned above, iron, palladium, platinum and so on can be cited.

### Third Embodiment

As a third embodiment, the wiring pattern 33 having a different configuration from the first embodiment and the second embodiment will be explained with reference to FIG. 8. Note that in the third embodiment, different sections from the first embodiment will be explained.

In the present third embodiment, the wiring pattern ink X1 using chromium as the conductive micro particles and the wiring pattern ink X2 using silver as the conductive micro particles are stacked in the film pattern forming area 34 by repeatedly performing the material disposing step and the preliminary drying step explained in the first embodiment as shown in FIG. 8. Note that as shown in the drawings, the wiring pattern ink X1, the wiring pattern ink X2, and again the wiring pattern ink X1 are stacked in the film pattern forming area 34 in this order from the side of the substrate P. Namely, the wiring pattern ink X2 is disposed in the film pattern forming area 34 so as to be sandwiched by the layers of the wiring pattern ink X1.

And, by performing the thermal process/optical process step explained in the first embodiment on the wiring pattern ink X1 and X2, the wiring pattern 33 composed of the layers of chromium, silver, and chromium stacked in this order is formed in the film pattern forming area 34.

In the wiring pattern 33 thus configured, the adhesiveness between the silver layer and the substrate P is enhanced by the chromium layer, and oxidization or damage of the silver layer can be prevented by the chromium layer disposed on the silver layer. Therefore, according to the present embodiment, the wiring pattern 33 with enhanced adhesiveness, oxidization resistance, and scratch resistance can be obtained.

### Fourth Embodiment

As a fourth embodiment, the wiring pattern 33 having a different configuration from the first through third embodiments will be explained with reference to FIG. 9. Note that in the fourth embodiment, different sections from the first embodiment will be explained.

In the present fourth embodiment, wiring pattern ink X4 using manganese as the conductive micro particles, the wiring pattern ink X2 using silver as the conductive micro particles, and wiring pattern ink X5 using nickel as the conductive micro particles are stacked in the film pattern forming area 34 in this order from the side of the substrate P by repeatedly performing the material disposing step and the preliminary drying step explained in the first embodiment as shown in FIG. 9.

And, by performing the thermal process/optical process step explained in the first embodiment on the wiring pattern ink X2, X4, and X5, the wiring pattern 33 composed of the layers of manganese, silver, and nickel stacked in this order is formed in the film pattern forming area 34.

In the wiring pattern 33 thus formed, the adhesiveness between the silver layer and the substrate P is enhanced by the manganese layer disposed between the silver layer and the substrate P. Further, the nickel layer has a function of preventing degradation of the silver layer caused by plasma irradiation in addition to a function of enhancing the adhesiveness between the substrate P and the silver layer. Therefore, by disposing the nickel layer on the silver layer, the wiring pattern 33 capable of preventing the degradation of the silver layer when performing the plasma irradiation on the substrate P provided with the wiring pattern 33 can be obtained.

Note that the invention is not limited to the embodiments described above, but various modifications can be made within the spirit or the scope of the invention. For example, as the wiring pattern 33, a film pattern (a wiring pattern) composed of a conductive film and an insulating film can be formed by applying a wiring pattern ink particularly containing conductive micro particles on the substrate P as the first functional liquid, then performing a drying process and so on, applying thereon a water type ink (the second functional liquid) containing a material with insulating property, and then drying it.

Further, in the film pattern formed in accordance with the invention, the plurality of functional liquids can include the same material. In such a case, if a desired film thickness is not obtained by a single coating process, the desired film thickness can be obtained by repeating the process.

Still further, it can be arranged to form the film pattern according to the invention with a single functional liquid applying process. And, the kind of the film pattern is not limited to the wiring pattern, but can be an insulating pattern.

### EXPERIMENTAL EXAMPLE

Here, in order for investigating wettability of the banks derived from the polysilazane liquid formed in the embodiments described above with the various kinds of ink (functional liquids) and dispersion mediums used therefore, the contact angles (static contact angles) were examined. The results are shown below. Further, for comparison, the contact angles of the conventional banks made of acrylic resin were also examined. Further, regarding the banks made of acrylic resin, the contact angles with the ink were also examined after performing a lyophobic process by a plasma process using CF₄ gas. Note that in the following expressions regarding the bank materials, polysilazane means that polysilazane liquid was applied and finally transformed to poly-methyl siloxane.

| | CONTACT | |
|---|---|---|
| INK MATERIAL | ANGLE | BANK MATERIAL |
| WATER | 94° | POLYSILAZANE |
| TETRADECANE | 15° | POLYSILAZANE |
| Ag INK (HYDROCARBON | 24° | POLYSILAZANE |
| DISPERSION MEDIUM) | | |
| Mn INK (HYDROCARBON | 21° | POLYSILAZANE |
| DISPERSION MEDIUM) | | |
| Ag INK (WATER TYPE | 50° | POLYSILAZANE |
| DISPERSION MEDIUM) | | |
| Ni INK (WATER TYPE | 46° | POLYSILAZANE |
| DISPERSION MEDIUM) | | |
| WATER | 65° | ACRYLIC RESIN |
| WATER | 100° | ACRYLIC RESIN (WITH |
| | | LYOPHOBIC PROCESS) |
| TETRADECANE | 26° | ACRYLIC RESIN |
| TETRADECANE | 54° | ACRYLIC RESIN (WITH |
| | | LYOPHOBIC PROCESS) |

According to the experiment described above, it was confirmed that the banks derived from the polysilazane liquid (poly-methyl siloxane) according to the embodiments of the invention had preferable lyophobic properties with water, namely water-repellent properties of 94°, which was the same or superior to the contact angle (54°) of tetradecane with the conventional acrylic resin processed with the lyophobic process or the contact angle (100°) of water with the acrylic resin processed with the lyophobic process. Further, it was also confirmed that the ink (Ag ink and Ni ink) using the water type dispersion liquids exerted the preferable water-repellent properties.

Electro-Optic Device

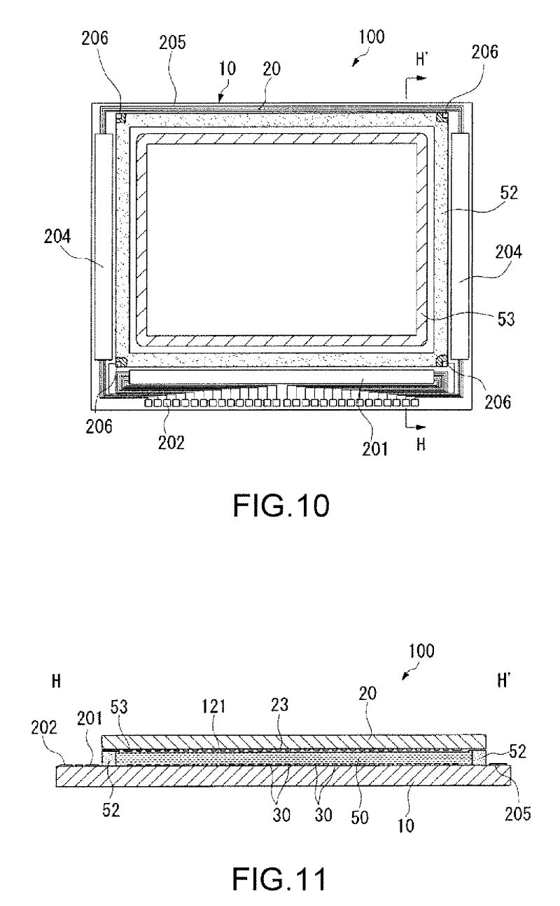

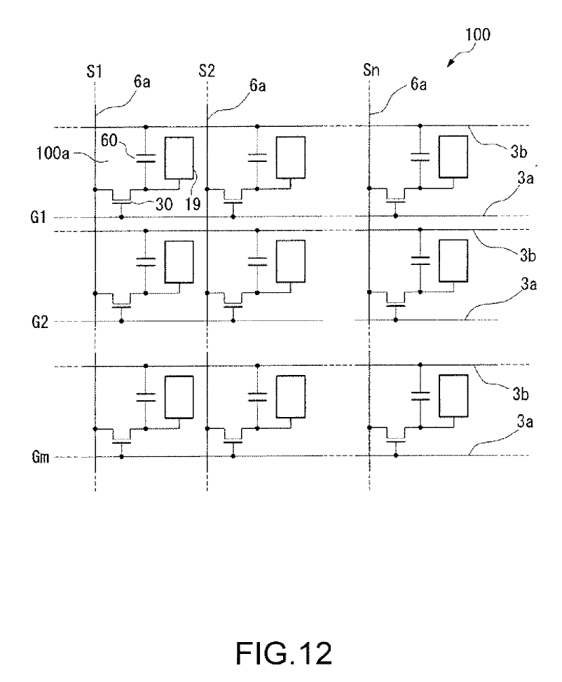

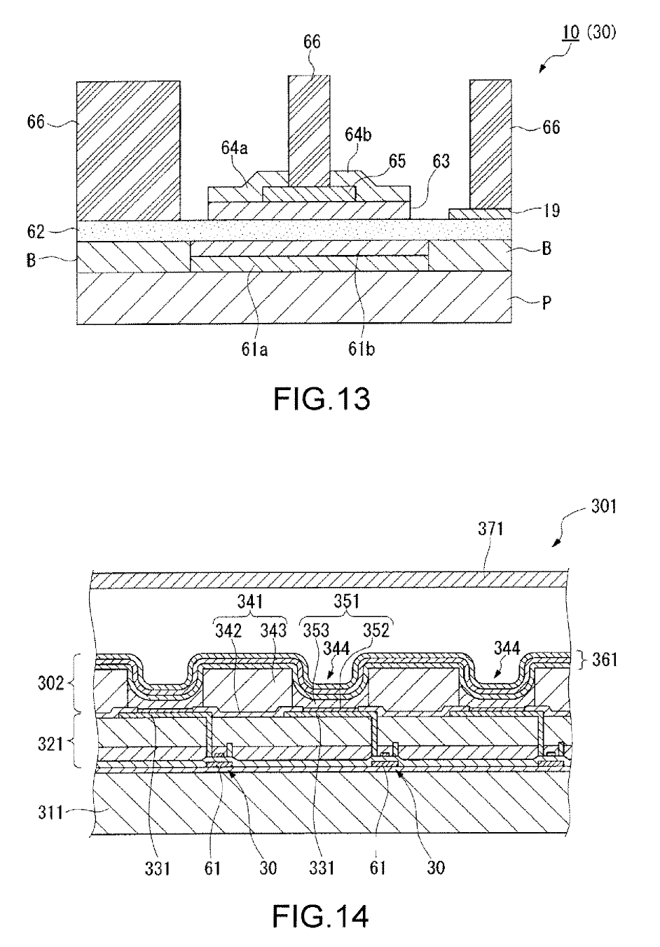

A liquid crystal display device, which is an embodiment of an electro-optic device according to the invention, will hereinafter be described. FIG. 10 is a plan view showing the liquid crystal display device according to the embodiment of the invention together with various composing elements viewed from an opposing substrate, and FIG. 11 is a cross-sectional view along the H-H′ line shown in FIG. 10. FIG. 12 is an equivalent circuit diagram of various elements and the wiring in a plurality of pixels formed in a matrix in an image display region of the liquid crystal display device, and FIG. 13 is a partial enlarged cross-sectional view of the liquid crystal display device.

In FIGS. 10 and 11, the liquid crystal display device (the electro-optic device) 100 according to an embodiment of the invention has a structure in which the TFT array substrate 10 and the opposing substrate 20 making a pair are adhered to each other with a seal member 52, which is a light curing sealant, and the liquid crystal 50 is encapsulated and held in the region partitioned with the seal member 52. The seal member 52 is formed in the surface of the substrate as a closed frame.

In the inside of the area in which the sealing member 52 is formed, there is provided a periphery cover 53 made of a light blocking material. In the outer area of the sealing member 52, there are provided a data line drive circuit 201 and mounting terminals 202 along one side of the TFT array substrate 10, and scanning line drive circuits 204 are formed along two sides adjacent to the one side. In the remaining side of the TFT array substrate 10, there are provided a number of wiring 205 for connecting the scanning line drive circuits 204, which are provided on the both sides of the image display area, to each other. Further, on at least one corner of the opposing substrate 20, there is provided an inter-substrate connecting member 206 for achieving electrical conduction between the TFT array substrate 10 and the opposing substrate 20.

Note that, it can be arranged that instead of forming the data line drive circuit 201 and the scanning line drive circuits 204 on the TFT array substrate 10, for example, a tape automated bonding (TAB) substrate is electrically and mechanically connected to a group of terminals provided to the periphery of the TFT array substrate 10 via an anisotropic conductive film. Further, although in the liquid crystal display device 100, a wave plate, a deflecting plate, and so on are disposed in appropriate orientations in accordance with a nature of the liquid crystal 50 used therein, namely the operational mode such as a twisted nematic (TN) mode, C-TN method, VA method, or IPS method, or which one of normally white mode and normally black mode is selected, the illustration thereof will be omitted here. Further, if the liquid crystal display device 100 is configured to be used as a color display, color filters for red (R), green (G), and blue (B), for example, are formed with their protective films in the area of the opposing substrate 20 facing the respective pixel electrodes, which are described below, of the TFT array substrate 10.

In the image display area of the liquid crystal display device 100 having such a structure, as shown in FIG. 12, a plurality of pixels 100a are configured as a matrix, and each of the pixels 100a is provided with a TFT (a switching device) 30 for pixel-switching, and the data line 6a for supplying a pixel signal S1, S2, . . . , or Sn is electrically connected to the source of the TFT 30. Note that FIG. 12 shows an example of active matrix substrate according to the invention.

The pixel signals S1, S2, . . . , Sn to be written to the data lines 6a can be supplied to the data lines 6a in this sequential order. Alternatively, every group of these signals is supplied to a plurality of data lines 6a adjacently located. Further, the scanning lines 3a are electrically connected to the gates of the TFTs 30, and it is configured that the scanning signals G1, G2, . . . , Gm are respectively supplied to the scanning lines 3a at a predetermined timing in forms of pulses in this order.

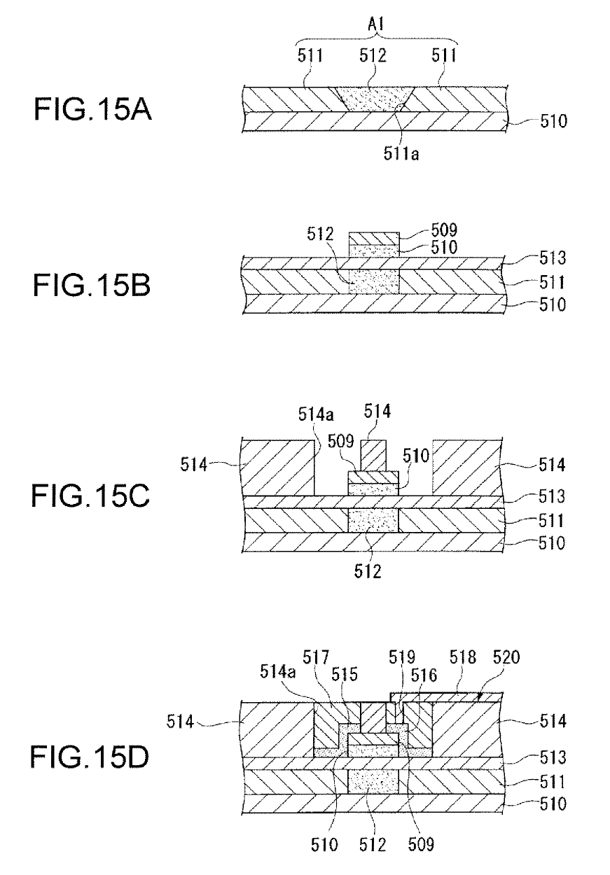

The pixel electrode 19 is electrically connected to the drain of the TFT 30. The TFT 30 as a switching element is turned on during a predetermined period of time, thereby writing Image signals S1, S2, . . . , Sn supplied from the data lines 6a to the respective pixels with predetermined timing. According to this operation, the image signals S1, S2, . . . , Sn of predetermined levels stored in the liquid crystal via the pixel electrodes 19 are held between the pixel electrodes and the opposing electrodes 121 of the opposing substrate 20 shown in FIG. 15 for a predetermined period of time. Note that, in order for preventing leakage of the pixel signals S1, S2, . . . , Sn held therebetween, storage capacitors 60 are additionally provided in parallel with the liquid crystal capacitors formed between the pixel electrodes 19 and the opposing electrodes 121. For example, the voltages of the pixel electrodes 19 are held by the storage capacitors 60 for about thousand times as long as the period for applying the source voltages. Accordingly, the charge holding performance is improved, thus the liquid crystal display device 100 having a high contrast ratio can be realized.

FIG. 13 is a partial enlarged cross-sectional view of the liquid crystal display device 100 having the TFT 30 of a bottom gate type. The bottom gate type TFT 30 shown in this drawing forms an example of a device according to the invention. The glass substrate P forming the TFT array substrate 10 is provided with a gate wiring 61 composed of a plurality of stacked layers each made of different material and formed by the film pattern forming method of the above embodiments. Note here that, since the inorganic bank material having polysiloxane framework as described above is used in forming the gate wiring 61 in the present embodiment, if the banks B is heated up to about 350° C. in a process for forming an amorphous silicon layer described below, it can sufficiently bear with the temperature. Further, in the present embodiment, the gate wiring 61 composed of a chromium layer 61a and a silver layer 61b stacked one another is illustrated as an example.

On the gate wiring 61, a semiconductor layer 63 composed of an amorphous silicon (a-Si) layer is stacked via a gate insulating film 62 made of SiNx. And, the area of the semiconductor layer 63 opposing to the gate wiring section is defined as the channel region. On the semiconductor layer 63, bonding layers 64a and 64b formed of, for example, n⁺ type of a-Si layer are stacked in order for obtaining ohmic contact, and in the center section of the channel region, an insulating etch stop film 65 made of SiNx for protecting the channel is formed on the semiconductor layer 63. Note that the gate insulating film 62, the semiconductor layer 63, and the etch stop film 65 can be patterned as shown in the drawing by coated with the resist, exposed and developed, and then photo-etched after deposited (CVD).

Further, the bonding layers 64a, 64b and the pixel electrode 19 made of ITO can also be patterned as shown in the drawing by photo-etched after similarly deposited. And, the banks 66 are provided on the pixel electrode, the gate insulating film 62, and the etch stop film 65, and then the source line and the drain line are formed between the banks 66 using the droplet ejection device IJ described above. Note that by forming the banks 66 from the polysilazane liquid according to the embodiments of the invention, the source line and the drain line can also be formed as the film patterns according to the embodiment of the invention.

Therefore, in the present embodiment, the gate line 61, the source line, and the drain line can be formed as wiring patterns composed of stacked layers each formed of different material, thus the gate line 61, the source line, and the drain line each having a plurality of functionalities can be obtained.

Note that, if the wiring patterns are composed of two layers of a chromium layer and a silver layer as explained in the first embodiment, the liquid crystal display device 100 having the enhanced adhesiveness of the gate line 61, the source line, and the drain line. Further, if the wiring patterns are composed of a titanium layer, a silver layer, and a titanium layer stacked in this order as described in the second embodiment, the liquid crystal display device 100, in which the electromigration of the gate line 61, the source line, and the drain line are suppressed, can be obtained. Further, if the wiring patterns are composed of a chromium layer, a silver layer, and a chromium layer stacked in this order as described in the third embodiment, the liquid crystal display device 100, in which the adhesiveness, the oxidation resistance, and the scratch resistance of the gate line 61, the source line, and the drain line are enhanced, can be obtained. Further, if the wiring patterns are composed of a manganese layer, a silver layer, and a nickel layer stacked in this order as described in the fourth embodiment, the liquid crystal display device 100, in which the adhesiveness of the gate line 61, the source line, and the drain line is enhanced, and the degradation caused by a silver plasma process is prevented, can be obtained.

Although the configuration of using the TFT 30, which is an embodiment of the device according to the invention, as a switching element for driving the liquid crystal display device 100, is adopted in the above embodiment, it can also be applied to, for example, an organic electroluminescence (EL) display device other than the liquid crystal display device. The organic EL display device is an element having a structure, in which a thin film including an inorganic or an organic fluorescent compound is sandwiched by a cathode and an anode, and generating excitons by injecting electrons and holes to the thin film and exciting them, and emitting light utilizing emission (fluorescence or phosphorescence) of light caused by recombination of the excitons.

And, a light-emitting full-color EL device can be manufactured by respectively forming patterns on the substrate provided with TFTs 30 described above using ink of the light emitting layer forming materials, namely materials respectively presenting red, green, and blue selected from the fluorescent materials used for organic EL display elements, and ink of a material for forming a hole injection/electron transport layer.

Such an organic EL device is also included in the scope of the electro-optic device according to the invention. And, according to the invention, an organic EL device equipped with wiring patterns each having a plurality of functionalities, for example, can be provided.

FIG. 14 is a side cross-sectional view of the organic EL device in which some elements are manufactured by the droplet discharging device IJ. A schematic configuration of the organic EL device will be explained with reference to FIG. 14.

In FIG. 14, the organic EL device 301 is formed of an organic EL element 302 composed of a substrate 311, a circuit element section 321, pixel electrodes 331, a bank section 341, light emitting elements 351, a cathode (an opposing electrode), and a sealing substrate 371, connected to wiring patterns of a flexible board (not shown) and a drive IC (not shown). The circuit element section 321 is composed of the TFTs 30 as active elements formed on the substrate 311, and a plurality of pixel electrodes 331 aligned on the circuit element section 321. And, the gate wiring 61 partially forming the TFT 30 is formed by the method of forming the wiring pattern according to the embodiments described above.

The bank section 341 is formed between the pixel electrodes 331 in a reticular pattern, and the light emitting element 351 is formed in each of recessed openings 344 defined by the bank 341. Note that the light emitting elements 351 are composed of elements for emitting red light, elements for emitting green light, and elements for emitting blue light, thus the organic EL device 301 realizes the full-color display. The cathode 361 is formed on entire upper surface of the bank section 341 and the light emitting elements 351, and the sealing substrate 371 is stacked on the cathode 361.

A manufacturing process of the organic EL device 301 including the organic EL element includes a bank forming step for forming the bank section 341, a plasma process step for appropriately forming the light emitting elements 351, a light emitting element forming step for forming the light emitting elements 351, an opposing electrode forming step for forming the cathode 361, and a sealing step for stacking the sealing substrate 371 on the cathode 361 to complete the sealing.

The light emitting element forming step is for forming the light emitting elements 351 by forming hole injection layers and light emitting layers in the recessed openings 344, namely on the pixel electrodes 331, and includes a hole injection layer forming step and a light emitting layer forming step. And, the hole injection layer forming step includes a first discharging step for discharging a liquid material for forming the hole injection layers 352 on each of the pixel electrodes 331 and a first drying step for forming the hole injection layers 352 by drying the discharged liquid material. Further, the light emitting layer forming step includes a second discharging step for discharging a liquid material for forming the light emitting layers 353 on the hole injection layers 352 and a second drying step for forming the light emitting layers 353 by drying the discharged liquid material. Note that it is arranged that three types of layers corresponding to the three colors of red, green, and blue as the light emitting layers 353, and accordingly, the second discharging step is composed of three steps for respectively discharging three kinds of materials.

In the light emitting element forming step, the droplet discharging device IJ can be used in the first discharging step in the hole injection layer forming step and the second discharging step in the light emitting layer forming step.

Although in the embodiments described above, the gate wiring of the thin film transistor (TFT) is formed using the film pattern forming method according to the present invention, other elements such as the source electrode, the drain electrode, or the pixel electrode can also be manufactured. A method of manufacturing a TFT will hereinafter be explained with reference to FIGS. 15A through 15D.

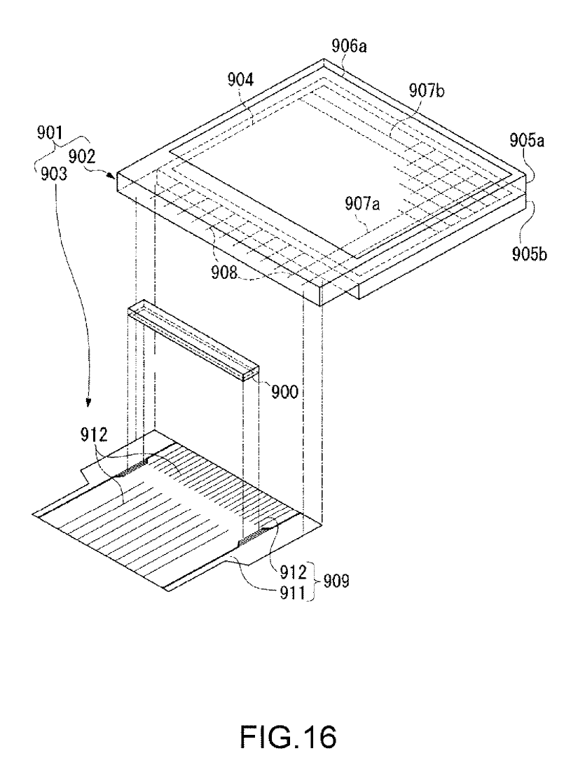

Firstly, as shown in FIG. 16A, a first layer bank 511 for providing a groove 511a of a twentieth through tenth of one pixel pitch is formed on the upper surface of a cleaned glass substrate 510 using the polysilazane liquid described above. The bank made of an inorganic material having polysiloxane as the framework thus derived from polysilazane has a water-repellent property and also optical transparency as described above.

In a gate scanning electrode forming step following the first layer bank forming step, a gate scanning electrode 512 is formed by discharging droplets of water type functional liquid containing conductive material with inkjet so that the groove 511a as a drawing area partitioned by the bank 511 is filled with the water type functional liquid. Namely, the film pattern forming method according to the invention is applied in forming the gate scanning electrode 512.

As the conductive material in this case, Ag, Al, Au, Cu, palladium, Ni, W—Si, or conductive polymer can preferably be adopted. The gate scanning electrode 512 thus formed can be formed as a fine wiring pattern without running off the groove 511a because the bank 511 has a sufficient water-repellent property.

According to the steps described above, the first conductive layer Al made of silver (Ag) and having a flat upper surface composed of the bank 511 and the gate scanning electrode 512 is formed on the substrate 510.

Further, in order for obtaining a preferable discharging result in the groove 511a, as shown in FIG. 16A, a forward tapered shape (a tapered shape opening towards the discharging source) is preferably adopted as the shape of the groove 511a. Thus, it becomes possible to make the discharged droplets enter sufficiently deep therein.

Subsequently, as shown in FIG. 15B, a gate insulating film 513, an active layer 510, and a contact layer 509 are continuously formed by a plasma CVD method. A silicon nitride film as the gate insulating film 513, an amorphous silicon film as the active layer 510, and an n⁺ type silicon film as the contact layer 509 are formed while alternating the material gases and modifying the plasma conditions. When forming with the CVD method, a thermal history of 300° C. through 350° C. is necessary. However, by using the inorganic bank derived from the polysilazane liquid, the problem regarding transparency or thermal resistance can be avoided.

In a second bank forming step following the semiconductor layer forming step, as shown in FIG. 15C, a second layer bank 514 for providing a groove 514a of a twentieth through tenth of one pixel pitch and traversing the groove 511a is formed on the upper surface of the gate insulating film 513 also using the polysilazane liquid described above. The bank made of an inorganic material thus derived from polysilazane has a water-repellent property and also optical transparency as described above.

In a source and drain electrode forming step following the second layer bank forming step, a source electrode 515 and a drain electrode 516 both traversing the gate scanning electrode 512 is formed by discharging droplets of water type functional liquid containing conductive material with inkjet so that the groove 514a as a drawing area partitioned by the bank 514 is filled with the water type functional liquid. And, the film pattern forming method according to the invention is applied to formation of the source electrode 515 and the drain electrode 516.

As the conductive material in this case, Ag, Al, Au, Cu, palladium, Ni, W—Si, or conductive polymer can preferably be adopted. The source electrode 515 and the drain electrode 516 thus formed can be formed as a fine wiring pattern without running off the groove 514a because the bank 514 has a sufficient water-repellent property.

Further, a insulating material 517 is disposed so as to fill in the groove 514a in which the source electrode 515 and the drain electrode 516 are disposed. According to the steps described above, a flat upper surface 520 composed of the bank 514 and the insulating material 517 is formed on the substrate 510.

And, a contact hole 519 is formed in the insulating material 517, a patterned pixel electrode (ITO) 518 is formed on the upper surface 520, the drain electrode 516 and the pixel electrode 518 are connected to each other via the contact hole 519, thereby forming the TFT.

FIG. 16 is a perspective view showing another embodiment of a liquid crystal display device.

A liquid crystal display device (an electro-optic device) 901 shown in FIG. 16 is roughly composed of a color liquid crystal panel (an electro-optic panel) 902 and a circuit board 903 to be connected to the liquid crystal panel 902. Further, a lighting device such as a backlight or other incidental equipment is attached to the liquid crystal panel 902 according to needs.

The liquid crystal panel 902 has a pair of substrates 905a and 905b adhered with a seal member 904, and liquid crystal is encapsulated in so-called cell gap, a gap formed between the substrate 905a and the substrate 905b. The substrates 905a and 905b are typically formed of a translucent material such as glass, synthetic resin or the like. Polarization plates 906a and 906b are adhered to the outer surfaces of the substrates 905a and 905b , respectively. Note that the polarization plate 906b is not shown in FIG. 16.

Further, an electrode 907a is formed on an inner surface of the substrate 905a, and an electrode 907b is formed on an inner surface of the substrate 905b. The electrodes 907a and 907b are formed to have shapes of stripes, characters, numbers, or other desired patterns. Further, the electrodes 907a and 907b are made of a translucent material such as indium tin oxide (ITO). The substrate 905a has a protruding section protruding from the substrate 905b, and a plurality of terminals 908 is formed on the protruding section. The terminals 908 are formed together with the electrode 907a while the electrode 907a is formed on the substrate 905a. Therefore, the terminals 908 are made of, for example, ITO. Those extending integrally from the electrode 907a and those connected to the electrode 907b via a conducting member (not shown) are included in the terminals 908.

The circuit board 903 is provided with a semiconductor element 900 as a liquid crystal drive IC mounted in a predetermined position on the wiring board 909. Note that although not shown in the drawings, chip parts such as a resistor, a capacitor, and so on can be mounted on predetermined positions other than the position where the semiconductor element 900 is mounted. The wiring board 909 is manufactured by forming wiring patterns 912 by patterning a metal film such as Cu formed on a film like base substrate 911 with flexibility such as polyimide.

In the present embodiment, the electrodes 907a and 907b in the liquid crystal panel 902 and the wiring patterns 912 in the circuit board 903 are formed by the film pattern forming method according to the invention. Therefore, according to the liquid crystal display device of the present embodiment, by providing the film pattern such as the wiring patterns 912 patterned with accuracy as described above and offering enhanced productivity, the liquid crystal itself becomes preferable.

Note that, although the example described above is a passive type liquid crystal panel, an active matrix type liquid crystal panel can also be adopted. Namely, thin film transistors (TFTs) are formed on one of the substrates, and a pixel electrode is formed corresponding to each of the TFTs. Further, the wiring (the gate wiring and the source wiring) electrically connected to each of the TFTs can be formed using the inkjet technology as described above. Meanwhile, the opposing electrode and so on are formed on the opposing substrate. The invention can also be applied to such an active matrix type of liquid crystal panel.

Specific examples of an electronic apparatus according to the invention are hereinafter described.

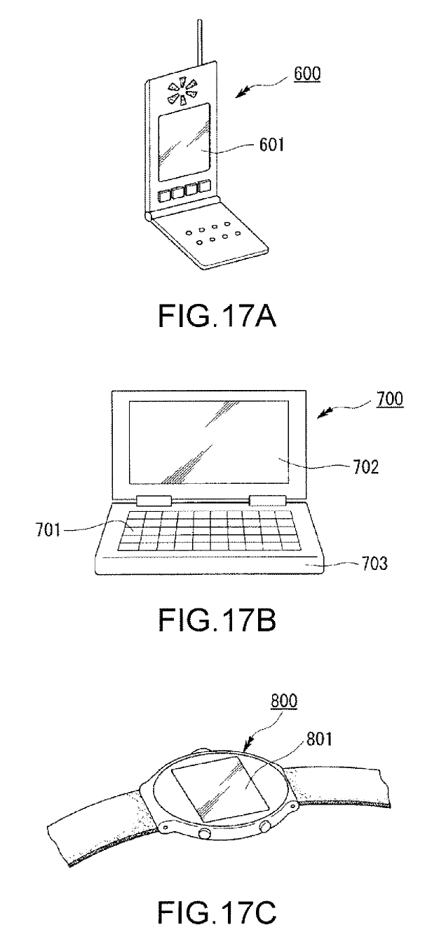

FIG. 17A is a perspective view showing an example of a cellular phone. In FIG. 17A, the reference numeral 600 denotes a main body of the cellular phone, and the reference numeral 601 denotes a liquid crystal display section equipped with the liquid crystal display device according to the above embodiment.

FIG. 17B is a perspective view showing an example of a portable data processing device such as a word processor or a personal computer. In FIG. 17B, the reference numeral 700 denotes an information processing device, the reference numeral 701 denotes an input section such as a keyboard, the reference numeral 703 denotes an information processing main body, and the reference numeral 702 denotes a liquid crystal display section equipped with the liquid crystal display device according to the above embodiment.

FIG. 17C is a perspective view showing an example of a wrist watch type of electronic apparatus. In FIG. 17C, the reference numeral 800 denotes a main body of the watch, and the reference numeral 801 denotes a liquid crystal display section equipped with the liquid crystal display device according to the above embodiment.

Since the electronic apparatuses shown in FIGS. 17A through 17C are equipped with the liquid crystal display device according to the embodiment described above, the electronic apparatuses themselves become preferable.

Note that, although the electronic apparatuses according to the present embodiment are described as being equipped with the liquid crystal display device, they can be electronic apparatuses equipped with another electro-optic device such as an organic electroluminescence display device or a plasma display device.

What is claimed is:

1. A method of forming a film pattern by disposing a functional liquid on a substrate, comprising:
forming a bank on the substrate, the bank corresponding to an area on which the film pattern is to be formed;
disposing the functional liquid to the area partitioned by the bank; and
curing the functional liquid to form the film pattern,
wherein in the step of forming the bank, one of a polysilazane liquid and a polysiloxane liquid is applied, exposed, developed, patterned, and burnt, thereby forming the bank made of a material having a hydrophobic group in the side chain and a siloxane bond as a framework, and
a liquid containing one of a water type dispersion medium and a water type solvent is used as the functional liquid.

2. The method of forming a film pattern according to claim 1,
wherein the hydrophobic group is a methyl group.

3. The method of forming a film pattern according to claim 1,
wherein, as one of the polysilazane liquid and the polysiloxane liquid, one of a photosensitive polysilazane liquid and a photosensitive polysiloxane liquid containing a photoacid generator and functioning as a positive type resist is used, respectively.

4. The method of forming a film pattern according to claim 1,
wherein a functional material included in the functional liquid is a conductive material.

5. A method of forming a film pattern by disposing a functional liquid on a substrate, comprising:
forming a bank on the substrate, the bank corresponding to an area on which the film pattern is to be formed;
disposing a first functional liquid to the area partitioned by the bank;
disposing a second functional liquid on the disposed first functional liquid; and
forming the film pattern composed of a plurality of materials stacked one another by performing a predetermined process on the first functional liquid and the second functional liquid stacked one another in the area partitioned by the bank,
wherein in the step of forming the bank, one of a polysilazane liquid and a polysiloxane liquid is applied, exposed, developed, patterned, and burnt, thereby forming the bank made of a material having a hydrophobic group in the side chain and a siloxane bond as a framework, and
a liquid containing one of a water type dispersion medium and a water type solvent is used as the first functional liquid, and a liquid containing one of a water type dispersion medium and a water type solvent is used as the second functional liquid.

6. The method of forming a film pattern according to claim 5,
wherein the hydrophobic group is a methyl group.

7. The method of forming a film pattern according to claim 5,
wherein, as one of the polysilazane liquid and the polysiloxane liquid, one of a photosensitive polysilazane liquid and a photosensitive polysiloxane liquid containing a photoacid generator and functioning as a positive type resist is used, respectively.

8. The method of forming a film pattern according to claim 5,
wherein the first functional liquid and the second functional liquid contain different kind of functional materials from each other.

9. The method of forming a film pattern according to claim 5,
wherein the first functional liquid is cured prior to the step of disposing the second functional liquid on the disposed first functional liquid.

10. The method of forming a film pattern according to claim 5,
wherein the functional materials respectively included in the first functional liquid and the second functional liquid are both conductive materials.

11. The method of forming a film pattern according to claim 5,
wherein the second functional liquid contains a second functional material for taking on a primary function of the film pattern to be formed while the first functional liquid contains a first functional material for enhancing adhesiveness between the second functional material and the substrate.

12. The method of forming a film pattern according to claim 5,
wherein one of the first functional liquid and the second functional liquid contains a main material for taking on the primary function of the film pattern to be formed while the other contains a material for suppressing electromigration of the main material.

13. The method of forming a film pattern according to claim 5,
wherein one of the first functional liquid and the second functional liquid contains a main material for taking on the primary function of the film pattern to be formed while the other contains a material having an insulating property.

14. The method of forming a film pattern according to claim 5,
wherein one of the first functional liquid and the second functional liquid contains a main material for taking on the primary function of the film pattern to be formed while the other contains a material for suppressing plasma damage of the main material.

15. The method of forming a film pattern according to claim 14,
wherein the material for suppressing plasma damage of the main material is a barrier material for suppressing diffusion caused by the plasma damage.

16. A film pattern formed by the method according to claim 1.

17. A device comprising the film pattern according to claim 16.

18. An electro-optic device comprising the device according to claim 17.

19. An electronic apparatus comprising the electro-optic device according to claim 18.

20. A method of manufacturing an active matrix substrate, comprising:
(a) forming a gate wiring on a substrate;
(b) forming a gate insulating film on the gate wiring;
(c) stacking a semiconductor layer via the gate insulating film;
(d) forming a source electrode and a drain electrode on the gate insulating layer;
(e) disposing an insulating material on the source electrode and the drain electrode; and
(f) forming a pixel electrode on the disposed insulating material,
wherein the method of forming a film pattern according to claim 1 is used in at least one of the steps (a), (d), and (f).
